(19) United States
(12) Patent Application Publication
(10) Pub. No.: US 2010/0111664 A1
(43) Pub. Date: May 6, 2010

(54) METHOD OF USING A SLING JIG ASSEMBLY FOR LOADING AND TRANSPORTING BAGGED AND BUNDLED PRODUCTS

(75) Inventor: Richard James Sampson, Vancouver, WA (US)

Correspondence Address: MARGER JOHNSON & MCCOLLOM, P.C., 210 SW MORRISON STREET, SUITE 400, PORTLAND, OR, 97204, US

(73) Assignee: COLUMBIA/OKURA LLC, Vancouver, WA (US)

(21) Appl. No.: 12/685,613

(22) Filed: Jan. 11, 2010

Related U.S. Application Data
(62) Division of application No. 11/424,496, filed on Jun. 15, 2006.
(60) Provisional application No. 60/692,385, filed on Jun. 20, 2005.

(51) Int. Cl. B65G 57/00

(52) U.S. Cl. 414/802

(57) ABSTRACT

A method for loading a sling having a bottom and sidewalls comprises placing the sling bottom on a raised platform and rolling the sidewalls down into a gutter surrounding the raised platform so that the sidewalls form a negative angle with the sling bottom. Bagged product is then loaded onto the bottom of the sling to form a stack. The sling sidewalls are then rolled up the sidewalls up the stack sides so that the sidewalls form a positive angle with the sling bottom and the sling now encloses the stack of product. The sling jig assembly includes a raised central platform on which is adapted to rest the bottom of the sling. A gutter formed about the periphery of the central platform is adapted to receive the rolled-down sidewalls of the sling.

### CROSS-REFERENCES TO RELATED APPLICATIONS

This application is a divisional application of U.S. patent application Ser. No. 11/424,496, which itself claims the benefit from U.S. Provisional Patent Application No. 60/692,385 filed Jun. 20, 2005 whose contents are incorporated herein for all purposes.

### BACKGROUND OF THE INVENTION

1. Field of the Invention

This invention relates generally to containment systems and more particularly to methods and apparatuses for facilitating the loading operation of a sling device for use with transporting bagged or bundled goods.

2. Description of the Prior Art

Granulated products such as seed, fertilizer, grains, and the like are typically contained in nylon, cotton, burlap or plastic bags. When transporting mass quantities of such bags, the individual bags are stacked on pallets and lifted from below by forklift from place to place. When such products are shipped for export on a vessel, however, it is more common to stack such bags 100 within a soft-sided sling as shown in FIG. 1. Such a sling would fully envelop bags 100, thereby preventing them from sliding from the stack when moved.

The sling includes a soft-sided outer bag 10 having a bottom 11 and sidewalls 13, conventionally formed from a strong fabric such as nylon. Surrounding the bag 10 are a web of support straps, such as support straps. The particular sling embodiment shown in FIG. 1 includes two straps on each vertical sidewall 13 of the sling bag 10, such as straps 12a, 12b along a facing sidewall of the bag and straps 12c and 12d along left and right sidewalls respectively. Strap guides 14a-14d receive straps 12a-12d, respectively, and wrap around the periphery of and especially underneath the bag 10. The straps 12a through 12d connect together over the top of bag 10 so that forklift forks 16a, 16b can be received within the gap 18 formed beneath the straps.

The traditional method for loading bags 100 within the sling is by hand. The sling is laid flat on a floor and workers would lift each bag or bundle from an unload point and place them within the sling. Once the sling is filled with stacked bags 100 as shown in FIG. 1, a forklift or overhead crane would lift the loaded sling by straps 12a-12d thereby causing the straps to cinch the sling closed. The act of individually moving bags to within the sling interior is extremely time intensive.

Accordingly, it is desired to provide a new process for loading bagged or bundled products within a sling for transport.

### SUMMARY OF THE INVENTION

The apparatus uses a robotic arm to pick and place individual bags of material as they present themselves at the pick-up position on an in-feed conveyor belt. The bags are placed on an inside, bottom surface of a sling bag whose sidewalls have been rolled down. The sling bag sits atop a sling jig assembly that includes a raised central platform on which the sling bottom sits, and a gutter surrounding the platform into which the sling sidewalls are rolled down into. The jig further has an underside support structure that is adapted to sit on a conveyor belt.

In use, the jig is fitted with a sling by placing the sling bottom on the raised jig platform and rolling the sling sidewalls down into the gutter. The jig is placed on a load conveyor and rolled into place in a load position adjacent the robotic arm. The robotic arm moves individual bags from the pickup position to the load position and places the bags in preprogrammed orientations on the sling bottom and jig platform. Once the bags have been stacked in rows on the platform, the sling sidewalls are rolled upward over the sides of the stack of bags and attached together at the top of the stack to form an enclosed bag. The loaded jig is then moved by the conveyor to an unload position where a forklift or rods of an overhead crane are passed through lifting straps on the sling. The sling is then lifted from the jig and moved to its stored position in a warehouse for future loading onto a ship (e.g. the hold of a cargo ship). The jig is then fitted with another sling and then moved via the load conveyor back to the load position where the load and unload steps are again performed.

The foregoing and other objects, features and advantages of the invention will become more readily apparent from the following detailed description of a preferred embodiment of the invention that proceeds with reference to the accompanying drawings.

### BRIEF DESCRIPTION OF THE DRAWINGS

FIG. 1 is a side elevation view of a sling loaded with bagged product.

FIG. 2 is a perspective view of a sling jig assembly constructed according to a preferred embodiment of the invention.

FIG. 3 is a plan view of the sling jig assembly of FIG. 2.

FIG. 4 is a side elevation view of the sling jig assembly of FIG. 2 shown along a long side of the jig.

FIG. 5 is a side elevation view of the sling jig assembly of FIG. 2 shown along a short side of the jig.

FIG. 6 is a perspective view of a load/unload assembly environment in which the sling jig assembly of FIG. 2 is used.

FIG. 7 is a sectioned view of the sling jig, taken along lines 7-7 of FIG. 3 with a sling bag mounted therein and product unloaded thereon.

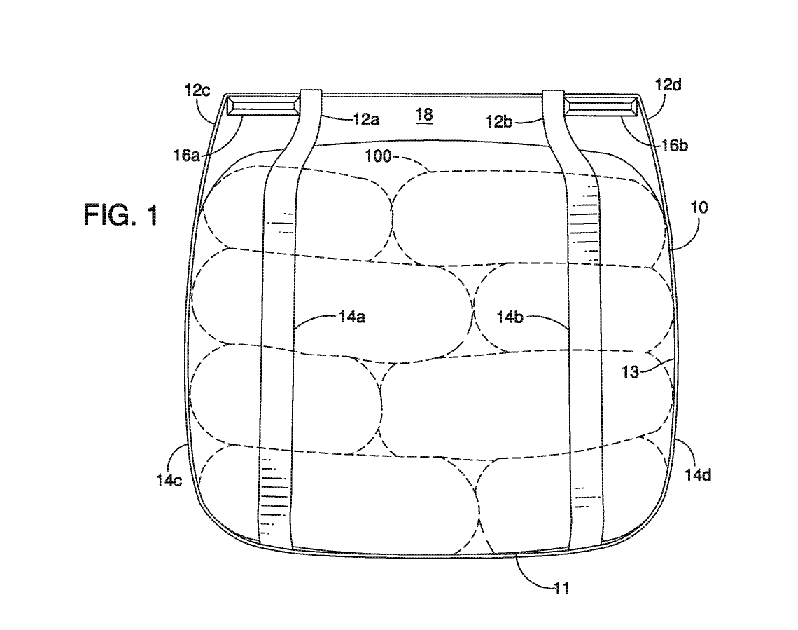

### DETAILED DESCRIPTION

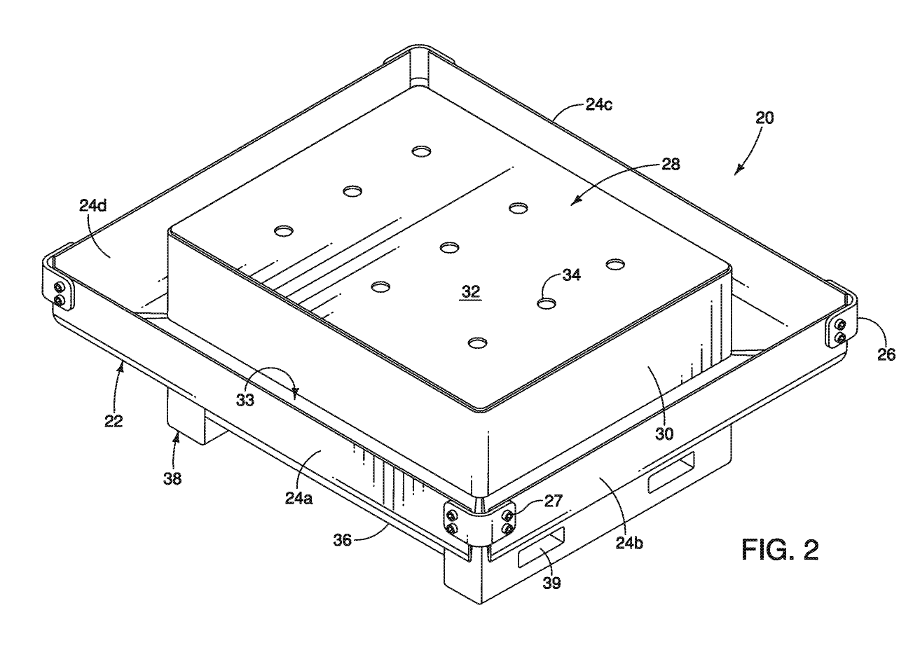

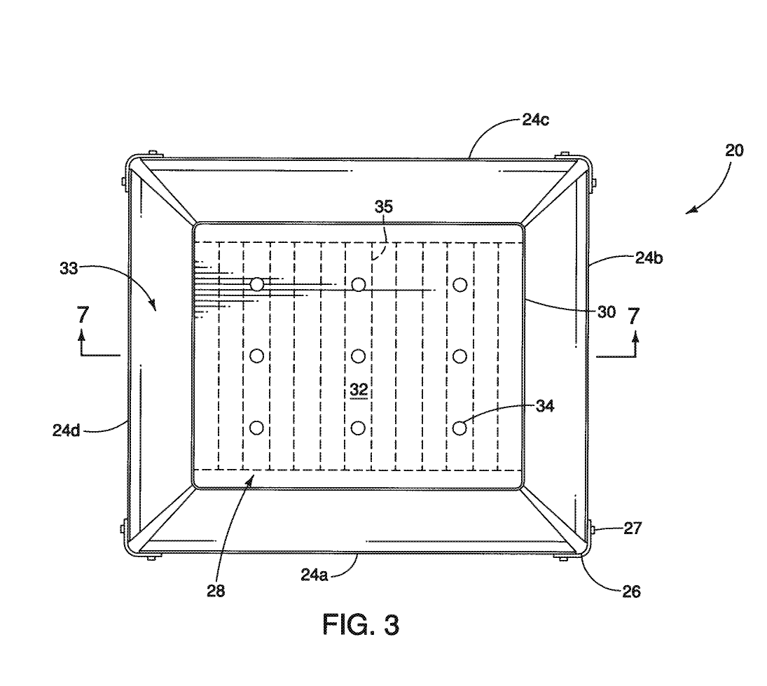

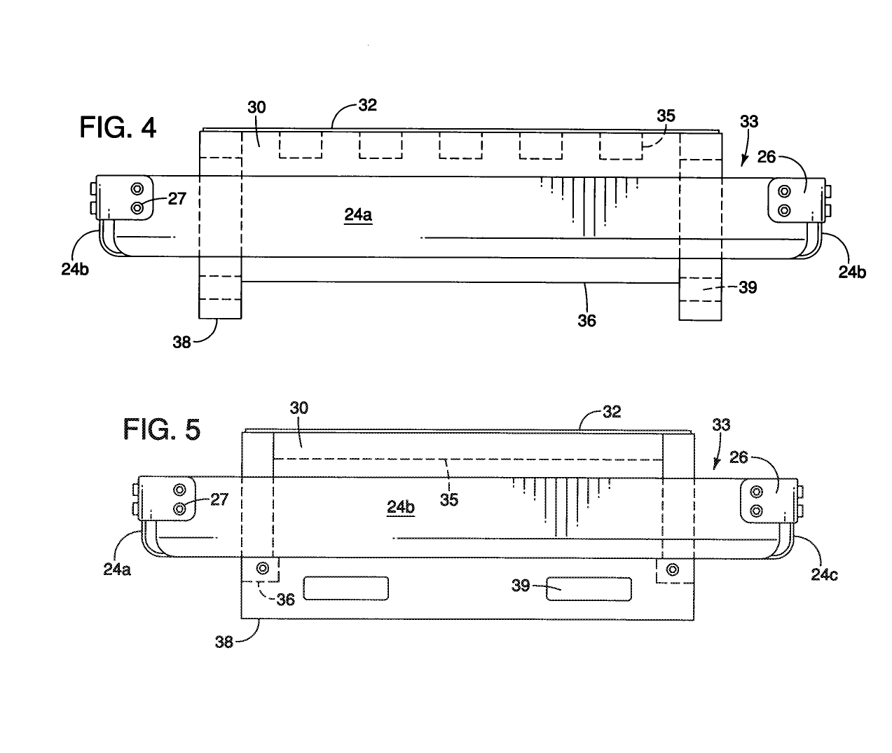

FIG. 2 shows a preferred embodiment of a sling jig assembly at 20 in perspective view. FIGS. 3-5 show top, front, and side views respectively.

Jig 20 is constructed to include an outer rectangular skirt 22 in which the four peripheral edges of skirt 22 are bent upward to form the flanges 24a-24d. Flanges 24a-24d are coupled together to adjacent flanges using metal ties, for instance metal tie 26 coupling flange 24b to flange 24c in FIG. 2 and coupling flange 24a and 24b in FIG. 3. The metal ties are affixed to the flanges via a set of bolts 27.

A raised platform 28 is placed on top of skirt 22 and between flanges 24a-24d. Platform 28 includes sidewalls 30 defining a rectangular periphery of platform 28 and having a raised platform top surface 32 that projects above a bottom surface formed within skirt 22. The sidewalls 30 of the raised platform 28 and the flanges 24a-24d of the skirt 22 form a trough or gutter 33 therebetween that runs about the periphery of raised platform 32.

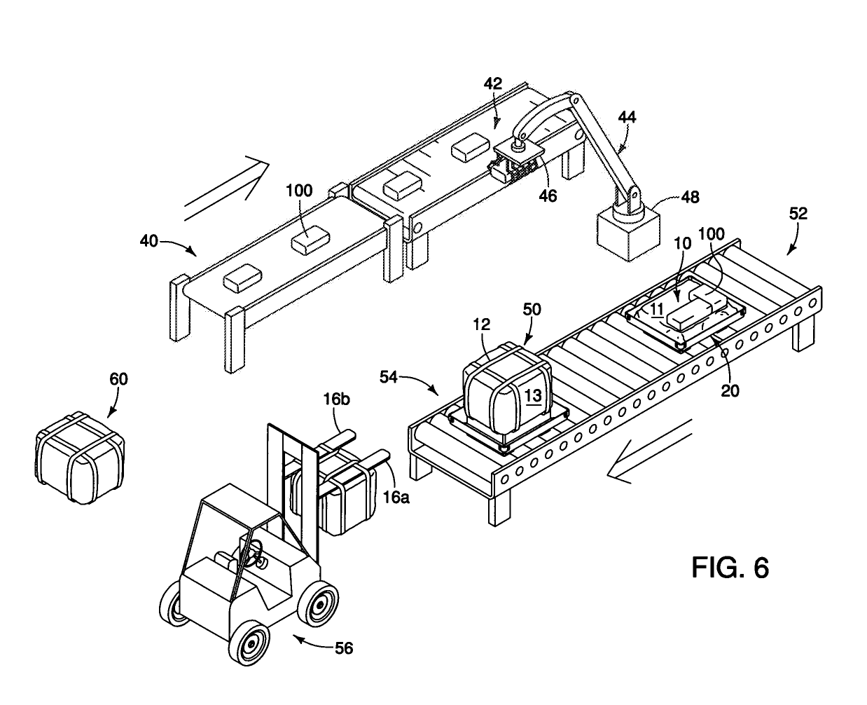

A preferred embodiment of the jig 20 includes an array of apertures 34 formed through top surface 32 to allow air to escape as the sling is placed on the jig. Metal support struts 35 (shown in dashed lines in FIG. 3) are fixed beneath top surface 32 to increase the strength of the jig assembly. A support structure affixed to an underside of the jig comprises sets of support beams 38 and 36 running perpendicular to one another. Beams 38, positioned on each side of beams 36 to form a box therewith, extend below a bottom surface of beams 36 and are adapted to contact and sit on a conveyor, such as load conveyor 52 shown in FIG. 6. At set of spaced apertures 39 are formed through beams 38 to act as forklift pockets for side access and lifting of jig 20 by forklift means 56.

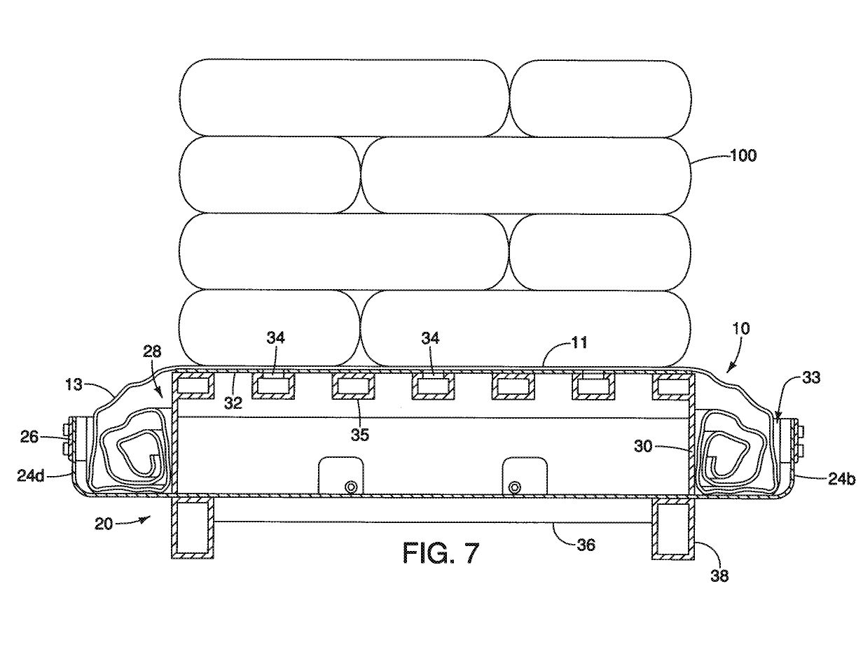

In operation, and as shown in FIGS. 6 and 7, a sling 10 is positioned within the jig 20 so that the sling bottom 11 and portions of the straps 12 sit atop the jig raised platform 28. The sling sidewalls 13 are then rolled down into the gutter 33 surrounding the raised platform 28 so that the sling sidewalls 13 make a negative angle (that is, angling downward) from the sling bottom 11. In this way, the sling bag is almost inside out. Bagged products 100 are then placed atop the sling bottom 11 with the sidewalls 13 rolled out of the way and not interfering with placement of the bagged product within the sling. Once loading is completed, the sling sidewalls 13 are rolled up over the sides of the stacked product and enclose the stack. The straps 12 of the sling are then coupled together to allow a forklift or overhead crane to move the loaded sling to another location.

FIG. 6 is a plan view of a load/unload assembly environment in which the sling jig assembly of FIG. 2 is used. The environment includes an in-feed conveyor 40 for transporting bagged products 100 serially to an unload position 42. A robotic arm 44, having an end effector or load/unload head 46 attached to a base 48 through a series of pivoted arms, engages with a bagged product at the unload position 42 whereby the load/unload head 46 of the robotic arm clamps on, thereby engaging bagged product 100. The engaged bag is then moved to a load position within the sling 10 mounted on the sling jig 20. Logic controls within the robotic arm are programmed to move between unload and load positions, with the load position changing with each successive pickup and placement depending upon where the next bagged product is to be placed on the stack.

Once loading is complete, the sling bag 10 can be rolled up over the stack as described above to form a wrapped bundle 50. The sling jig 20 and bundle 50 are then moved by load conveyor 52 for transport to an unload position 54. From the unload position, the loaded sling bag 10 is lifted from the jig 20 and moved for further transport, as via engagement of the tines 16a, 16b of forklift 56 shown in FIG. 6 with the straps 12 passing over the bundle 50 to create a webbing, to a subsequent shipping position 60. The unloaded jig 20 is then moved back into place at the load position, or a new jig put in its place to receive further bagged product from the in-feed conveyor 40 via robotic arm 44.

Having described and illustrated the principles of the invention in a preferred embodiment thereof, it should be apparent that the invention can be modified in arrangement and detail without departing from such principles. We claim all modifications and variation coming within the spirit and scope of the following claims.

What is claimed is:

1. A method for loading a sling having a bottom and sidewalls comprising:
placing the sling bottom on a raised platform;
rolling the sidewalls down so that the sidewalls form a negative angle with the sling bottom;
loading product onto the bottom of the sling to form a stack; and
rolling the sidewalls up the stack sides so that the sidewalls form a positive angle with the sling bottom.

2. The method of claim 1, wherein the step of rolling the sling sidewalls downward including rolling such sidewalls downward into a gutter surrounding the raised platform.

3. The method of claim 2, wherein the step of loading product onto the bottom of the sling includes:
providing a robotic arm with an end effector;
engaging the end effector with product at an unload position;
moving the robotic arm to a preprogrammed position over the bottom of the sling; and
disengaging the product from the end effector.

4. The method of claim 3, further including the step of repeating the engaging, moving, and disengaging step to form a stack of product and wherein the preprogrammed position is different for each repeated moving step.

5. The method of claim 3, further including the step of presenting product serially along a conveyor belt to the robotic arm at the unload position.

6. The method of claim 3, further including the step of moving the loaded sling along a conveyor belt to a sling unload position.
